(19) United States
(12) Patent Application Publication
(10) Pub. No.: US 2017/0139582 A1
(43) Pub. Date: May 18, 2017

(54) METHOD AND SYSTEM FOR CONTROLLING AN ILLUMINATION DEVICE AND RELATED LIGHTING SYSTEM

(71) Applicant: General Electric Company, Schenectady, NY (US)

(72) Inventors: Danijel Maricic, Niskayuna, NY (US); Stanislava Soro, Niskayuna, NY (US); Ramanujam Ramabhadran, Niskayuna, NY (US)

(21) Appl. No.: 14/940,833

(22) Filed: Nov. 13, 2015

(51) Int. Cl. G06F 3/0488; H05B 33/08; G06F 3/00; H05B 37/02; G06K 9/00; G06T 19/00

(52) U.S. Cl. CPC G06F 3/04883; G06K 9/00355; G06T 19/006; G06F 3/005; H05B 37/0272; H05B 33/0845

(57) ABSTRACT

A method for controlling an illumination device is provided. The method includes obtaining an image of an illumination device, thereby capturing an illumination pattern generated by the illumination device based on a visible light communication technique. The method also includes identifying the illumination pattern based on the image. The method further includes determining a unique identification code of the illumination device based on the illumination pattern. The method also includes representing the illumination device in a computer-generated image based on the unique identification code. The method further includes controlling the illumination device using a physical gesture-based graphic user interface.

### BACKGROUND

Embodiments of the present specification generally relates to illumination devices and, more particularly, to a method and a system for controlling an illumination device, and a related lighting system.

Illumination devices are generally used to illuminate a designated area. In applications, where an area to be illuminated is larger than the designated area of one illumination device, multiple illumination devices may be used to illuminate the area based on the size of the area and power ratings of the illumination devices being used to illuminate the area. Conventionally, in such applications, the multiple illumination devices were manually controlled, which was inefficient and time consuming. Therefore, a network based lighting system including multiple illumination devices is employed nowadays, which provides a more efficient approach to control the multiple illumination devices.

However, in applications such as industries, retail spaces, and warehouses, where network based lighting systems are employed, each of a networked illumination device needs to be commissioned and configured over multiple rooms and multiple floors. Each of the networked illumination devices is required to be associated with a respective physical location on the network based on which the networked illumination device is assigned a respective zone for further controls.

Such commissioning and configuration of the multiple illumination devices may lead to undesirable delays and human efforts. Hence, there is a need for an improved system and method for controlling the networked illumination devices.

### BRIEF DESCRIPTION

Briefly, in accordance with one embodiment, a method for controlling an illumination device is provided. The method includes obtaining an image of an illumination device, thereby capturing an illumination pattern generated by the illumination device based on a visible light communication technique. The method also includes identifying the illumination pattern based on the image. The method further includes determining a unique identification code of the illumination device based on the illumination pattern. The method also includes representing the illumination device in a computer-generated image based on the unique identification code. The method further includes controlling the illumination device using a physical gesture-based graphic user interface.

In another embodiment, a system for controlling an illumination device is provided. The system includes an imaging device configured to obtain an image of the illumination device, thereby capturing an illumination pattern of the illumination device generated based on a visible light communication technique. The system also includes a controlling device configured to determine a unique identification code of the illumination device based on the illumination pattern and enable a user to control the illumination device using a physical gesture-based graphic user interface.

In yet another embodiment, a lighting system is provided. The lighting system includes a light fixture configured to be operatively coupled to an illumination device. The lighting system further includes a visible light communication controller configured to be operatively coupled to at least one of the illumination device or the light fixture. The lighting system also includes an imaging device configured to obtain an image of the illumination device, thereby capturing an illumination pattern of the illumination device generated based on a visible light communication technique. The lighting system further includes a controlling device configured to determine a unique identification code of the illumination device based on the illumination pattern and enable a user to control the illumination device using a physical gesture-based graphic user interface.

### DRAWINGS

These and other features, aspects, and advantages of the present specification will become better understood when the following detailed description is read with reference to the accompanying drawings in which like characters represent like parts throughout the drawings, wherein:

FIG. 1 is a block diagram representation of a system for controlling an illumination device, according to an aspect of the present specification;

FIG. 2 is a block diagram representation of a lighting system for controlling an illumination device, according to an aspect of the present specification;

FIG. 3 is a block diagram representation of another embodiment of a lighting system for controlling an illumination device, according to an aspect of the present specification;

FIG. 4 depicts an illustrative example of a portable controlling device configured to determine a unique identification code based on an illumination pattern captured by an integrated imaging device in the portable controlling device, according to an aspect of the present specification;

FIG. 5 depicts an illustrative example of obtaining a first video clip using an imaging device, according to an aspect of the present specification;

FIG. 6 depicts an illustrative example of obtaining a second video clip using an imaging device, according to an aspect of the present specification;

FIG. 7 depicts an illustrative example of the video clip, where the first video clip of FIG. 5 and the second video clip of FIG. 6 are collated with other similar video clips to form the video clip, according to an aspect of the present specification;

FIG. 8 is an illustrative example depicting different hand gestures and control commands associated with the corresponding hand gestures and executed by the controlling device for controlling the illumination device, according to an aspect of the present specification; and

FIG. 9 is a flow chart representing steps involved in a method for controlling an illumination device, according to an aspect of the present specification.

### DETAILED DESCRIPTION

Unless defined otherwise, technical and scientific terms used herein have the same meaning as is commonly understood by one of ordinary skill in the art to which this disclosure belongs. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced items. The term “or” is meant to be inclusive and mean one, some, or all of the listed items. The use of “including,” “comprising” or “having” and variations thereof herein are meant to encompass the items listed thereafter and equivalents thereof as well as additional items.

Embodiments in the present specification include a system and method for controlling an illumination device. The system includes an imaging device configured to obtain an image of the illumination device, thereby capturing an illumination pattern of the illumination device generated based on a visible light communication technique. The system also includes a controlling device configured to determine a unique identification code of the illumination device based on the illumination pattern and enable a user to control the illumination device using a physical gesture-based graphic user interface. Lighting systems including such systems and methods for controlling an illumination device are also presented.

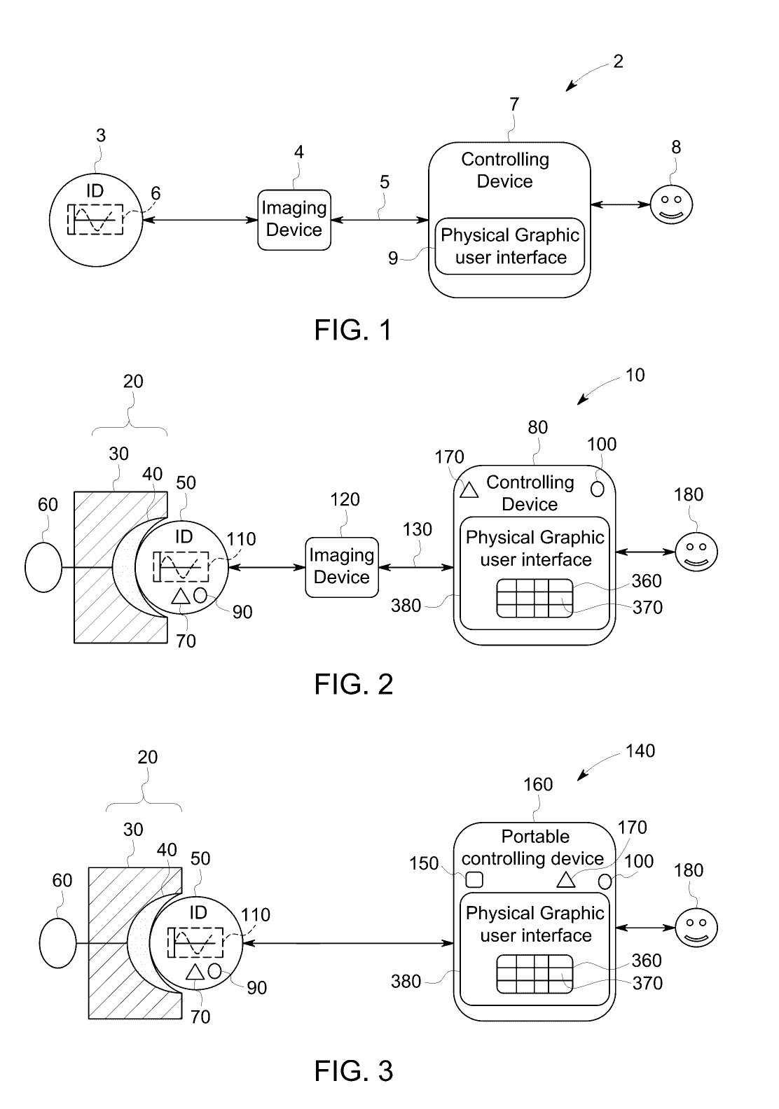

FIG. 1 is a block diagram representation of a system 2 for controlling an illumination device 3 according to one embodiment. The system 2 includes an imaging device 4 configured to obtain an image 5 of the illumination device 3, thereby capturing an illumination pattern 6 of the illumination device 3 generated based on a visible light communication technique. As used herein, the term “visible light communication technique” includes a technique which is used to perform data communication using visible light generated from an illumination device between two devices. The system 2 also includes a controlling device 7 configured to determine a unique identification code of the illumination device 3 based on the illumination pattern 6 and enable a user 8 to control the illumination device 3 using a physical gesture-based graphic user interface 9.

FIG. 2 is a block diagram representation of a lighting system 10, according to one embodiment. The lighting system 10 includes a light fixture 20. As used herein, the term “light fixture” may be defined as an electrical device used to create artificial light by use of an electrical illumination device. The light fixture 20 may be configured to be electrically coupled to an illumination device 50. In one embodiment, the light fixture 20 includes a fixture body 30 and a light socket 40 to hold an illumination device 50 and allow for its replacement. The light socket 40 may be operatively coupled to a power source 60 that provides electrical power to the illumination device 50 upon connecting the illumination device 50 to the light socket 40. The term “illumination device” as used herein refers to a single illuminate device or a plurality of illumination devices. In one embodiment, the illumination device 50 may include a light emitting diode (LED). In one embodiment, the illumination device 50 may include a string of LEDs.

The lighting system may further include a visible light communication (VLC) controller 70. In one embodiment, at least one of the illumination device 50 or the light fixture 20 may include the VLC controller 70. The VLC controller 70 may be configured to control the illumination device 50 to perform visible light communication upon receiving a signal representative of a presence of a controlling device 80. In some embodiments, the VLC controller 70 may be disposed in the illumination device 50 as shown in FIG. 2. In some other embodiments not shown in the figures, the VLC controller 70 may be disposed in the light fixture 40. In such instances, the light fixture 40 may be modified accordingly to include the VLC controller 70 for operating the illumination device 50.

The lighting system 10 further includes an imaging device 120 and a controlling device 80. As mentioned earlier, the imaging device 120 is configured to obtain an image 130 of the illumination device 50, thereby capturing an illumination pattern 110 of the illumination device 50 generated based on a visible light communication technique. The controlling device 80 is configured to determine a unique identification code of the illumination device 50 based on the illumination pattern 110 and enable a user 180 to control the illumination device 50 by using a physical gesture-based graphic user interface 380.

In one embodiment, the imaging device 120 may include a standalone imaging device separate from the controlling device 80. In one embodiment, the imaging device 120 may include a handheld camera. In another embodiment, the imaging device 120 may be integrated with the controlling device 80 as depicted in FIG. 3. In one embodiment, the imaging device 120 is capable of obtaining a single image such as photos or a plurality of images such as videos.

FIG. 3 is a block diagram representation of another embodiment 140 of the lighting system 10 of FIG. 1, wherein an integrated imaging device 150 is provided in a portable controlling device 160. In one embodiment, the portable controlling device may include a tablet or a smartphone including an integrated camera. In another embodiment, the portable controlling device 160 may include a virtual reality glass.

In one embodiment, the illumination device 50 may further include a receiver 90 as shown in FIG. 2. Non-limiting examples of a receiver 90 include a radio frequency receiver or an infrared receiver. In another embodiment, the receiver 90 may be located in the light fixture 40 and the light fixture 40 may be modified accordingly for operating the illumination device 50 (not shown in Figures). The receiver 90 may be configured to receive a signal representative of the presence of the controlling device 80, which may be generated by a transmitter 100 present in the controlling device 80. In one embodiment, the transmitter 100 may be a radio frequency transmitter or an infrared transmitter based on the receiver 90 configuration. Upon detection of the controlling device 80, the VLC controller 70 may be configured to control the illumination device 50 to generate an illumination pattern 110 based on a unique identification code provided to the illumination device 50.

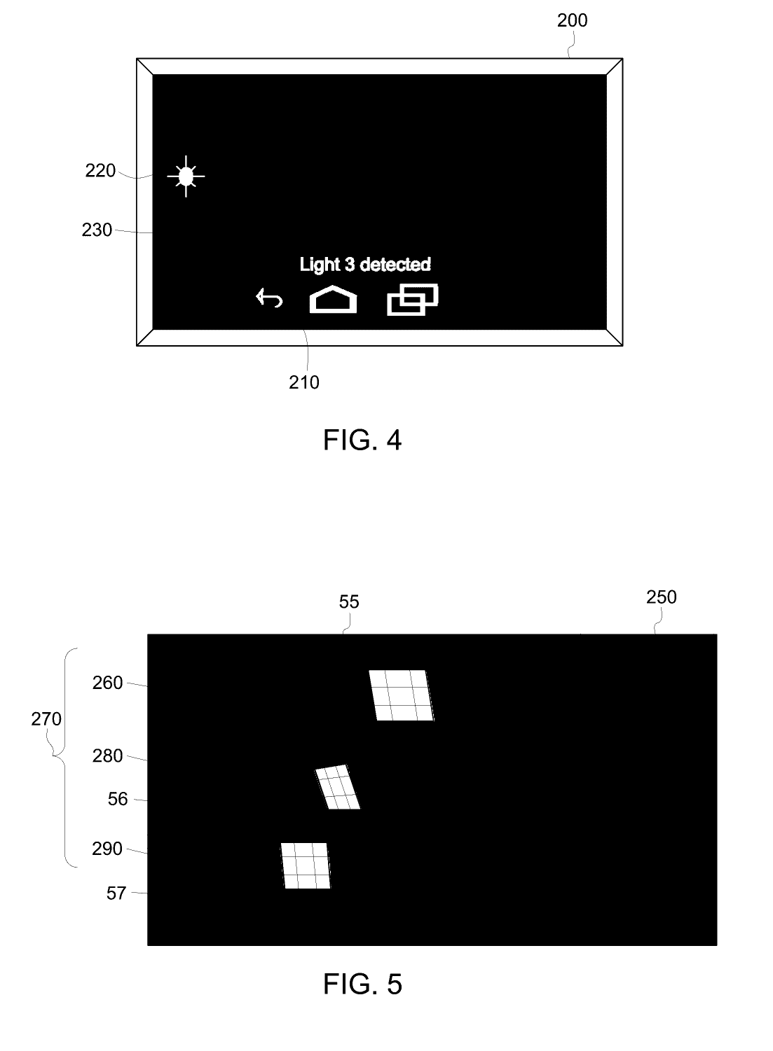

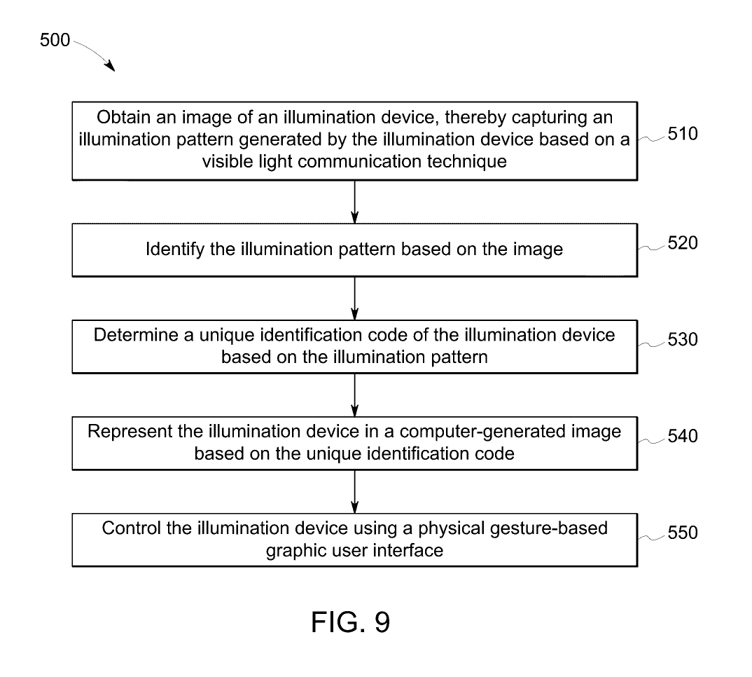

With the foregoing in mind, a method for controlling the illumination device in the lighting system is described in accordance with some embodiments of the specification. Referring now to FIGS. 2 and 9, the method 500 includes obtaining an image of the illumination device 50, thereby capturing the illumination pattern 110 generated by the illumination device 50 based on the visible light communication technique in step 510. The imaging device 120 captures the image 130 of the illumination device 50, where the image 130 includes the illumination pattern 110 of the illumination device 50. Furthermore, the controlling device 80 receives the image 130 from the imaging device 120 and uses the image 130 to identify the illumination pattern 110 generated by the illumination device 50, at step 520. The controlling device 80 further determines the unique identification code of the illumination device 50 based on the illumination pattern 110, at step 530. In one embodiment, the controlling device 80 includes a decoding module 170, which is configured to decode the unique identification code from the illumination pattern 110. In one embodiment, the decoding module 170 may also perform a cyclic redundancy check upon determining the unique identification code of the illumination device 50. The operation of the imaging device 120 and the controlling device 80 in accordance with different embodiments is described later in the specification with respect to illustrative examples shown in FIGS. 4-7.

FIG. 4 depicts an illustrative example of a portable controlling device 200 configured to determine a unique identification code 210 based on an illumination pattern captured by the integrated imaging device (FIG. 3) in the portable controlling device 200. In one embodiment, the portable controlling device 200 is a tablet. In the illustrative example, the portable controlling device 200 is held in a position such that the illumination device 220 is located within a field of view of the integrated imaging device. The integrated imaging device obtains an image of the illumination device 220 in real time, thereby capturing the illumination pattern. The image is transferred to the decoding module of the portable controlling device 200 in real time, which identifies the illumination pattern from the image and decodes the unique identification code 210 from the illumination pattern. As can be seen in FIG. 4, the portable controlling device 200 determines the unique identification code 210 of the illumination device as “light 3” and displays the unique identification code 210 on an integrated display 230 of the portable controlling device 200 adjacent to the illumination device 220 visible on the integrated display 230. In some embodiments, the image of the illumination device 220 may be stored in the portable controlling device 200 and may be processed later using the decoding module to determine the unique identification code 210 from the illumination pattern captured by the image. In other embodiments, the image of the illumination device 220 may be stored using cloud based services at a remote location and may be obtained later for further processing.

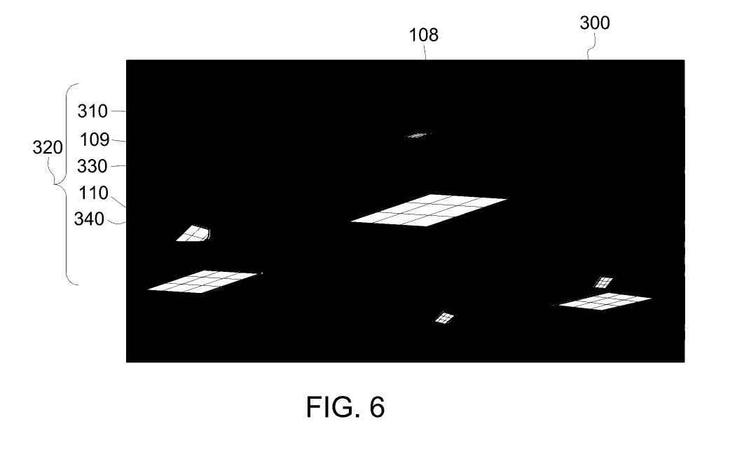

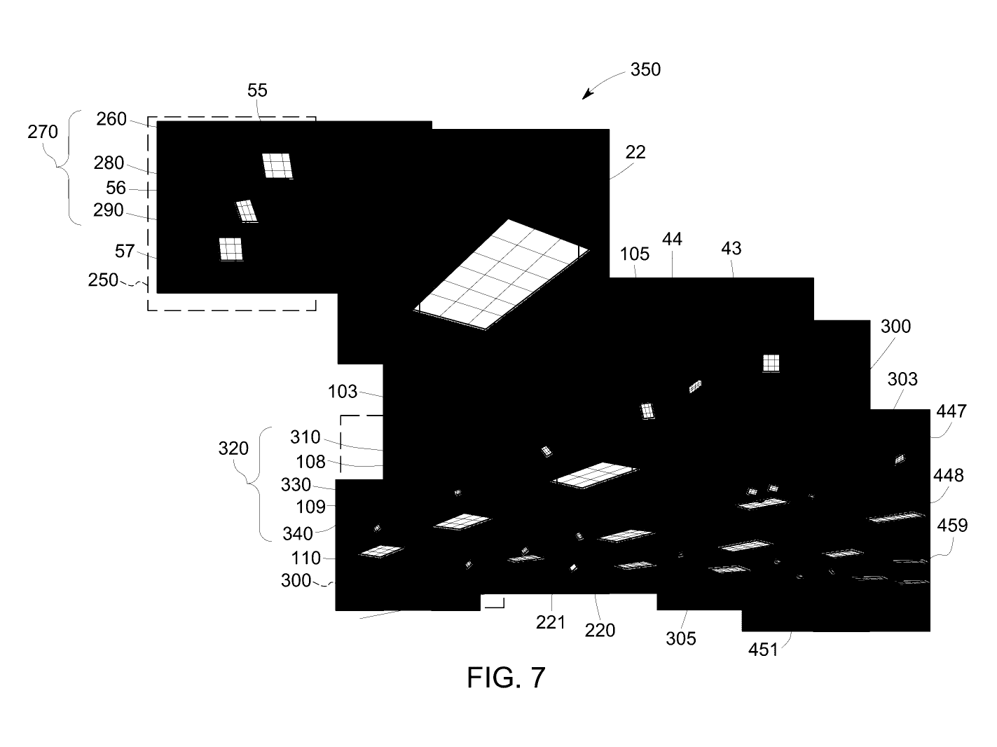

Referring back to FIG. 2, in some embodiments, the imaging device 120 may obtain a video clip (for example, as shown in FIG. 7) of a plurality of the illumination devices 50. The video clip may be obtained by the imaging device 120 in real time or may be stored using different mediums for further processing. In embodiments including an integrated imaging device, the video clip may be stored in the controlling device 80 or may be processed in real time using the decoding module 170 of the controlling device 80. In one embodiment, a user 180 of the imaging device 120 may obtain a first video clip of a first illumination device (as shown in FIG. 5) and a second video clip of the second illumination device (as shown in FIG. 6). The first video clip and the second video clip may be collated using the controlling device 80 to obtain the video clip (as shown in FIG. 7) including the images of the plurality of illumination devices 50.

FIG. 5 depicts an illustrative example of first video clip 250 obtained using the imaging device 120 of FIG. 2. The user 180 (as shown in FIG. 2) of the imaging device 120 may obtain the first video clip 250 including images of the first illumination device 260 or a first set of illumination devices 270 (including illumination devices 260, 280 and 290). As can be seen in FIG. 5, in the illustrative example, the first video clip 250 includes images of three illumination devices, where the unique identification codes of the three illumination devices are determined as fifty five (260), fifty six (280), and fifty seven (290) based on their illumination patterns. The three illumination devices 260, 280, 290 may be identified in real time, while obtaining the first video clip 250 or the first video clip 250 may be stored for processing later using the decoding module 170 of the controlling device 80.

FIG. 6 depicts an illustrative example of the second video clip 300 obtained using the imaging device 120 of FIG. 2. The user 180 of the imaging device 120 may obtain the second video clip 300 including images of the second illumination device 310 or the second set of illumination devices 320 (including illumination devices 310, 330 and 340). As can be seen in FIG. 6, in the illustrative example, the second video clip 300 includes images of three illumination devices, where the unique identification codes of the three illumination devices are determined as one hundred and eight (310), one hundred and nine (330), and one hundred and ten (340). The three illumination devices 310, 330, 340 may be identified in real time, while obtaining the second video clip 300 or the second video clip 300 may be stored for processing later using the decoding module 170 of the controlling device 80.

FIG. 7 depicts an illustrative example of the video clip 350, where the first video clip 250 of FIG. 5 and the second video clip 300 of FIG. 6 are collated with other similar video clips to form the video clip 350. Multiple video clips such as the first video clip 250 and the second video clip 300 may be collated together by the controlling device 80 form the video clip 350. The video clip 350 is used by the controlling device 80 to determine the unique identification codes of the plurality of illumination devices 50 in the first video clip 250 and the second video clip 300 such as fifty five (260), fifty six (280), fifty seven (290), one hundred and eight (310), one hundred and nine (330), and one hundred and ten (340) together.

With continued reference to FIGS. 2 and 9, the controlling device 80 uses the unique identification code of the illumination device 50 to represent the illumination device 50 in a computer-generated image 360, at step 540. In one embodiment, the computer-generated image 360 may include an augmented reality space or a virtual reality space. In one embodiment, the controlling device 80 may represent the illumination device 50 in the computer-generated image 360 based on a location of the illumination device 50 in a predetermined area.

In embodiments including the plurality of illumination devices 50, the plurality of illumination devices 50 may be represented in the computer-generated image 360 corresponding to their location in the predetermined area.

As mentioned earlier, each of the plurality of illumination devices 50 may be operatively coupled to the corresponding light fixture 40. Each light fixture 40 in the predetermined area may be assigned a light fixture location, which is used to generate a virtual layout 370 of all the light fixtures 40 in the computer-generated image 360. In one embodiment, the virtual layout 370 of the light fixtures 40 in the computer-generated image 360 may be divided in to a plurality of zones, sub-zones, and the light fixtures 40 may be represented as nodes in the virtual layout. The virtual layout 370 of the light fixtures 40 may be designed and classified based on a predetermined choice of the user 180 and may not be restricted to the aforementioned example including zones and sub-zones.

For example, if the predetermined area includes two buildings, each building may be represented as a zone, each floor of the building may be represented as a sub-zone, and each light fixture on each floor may be represented as the node. In another example, if the predetermined area includes only one building, each floor may be represented as a zone, each room may be represented as a sub-zone, different sections of the room may be represented as clusters, and each light fixture in each cluster may be represented as the node.

Furthermore, beacons at specific locations may be provided during the designing of the virtual layout. In one embodiment, the beacons may include radio frequency beacons or infrared beacons. The radio frequency beacons or the infrared beacons may be used based on the type of transmitter 100 and the receiver 90 in the lighting system 10. In one embodiment, the light fixtures 40 may operate as beacons. The beacons are used to provide a coarse location of the user 180 or the controlling device 80 once the user 180 or the controlling device 80 reaches within a predetermined distance of the beacon. In embodiments including a separate imaging device 120 (as shown in FIG. 2), the user 180 may have a radio frequency identification tag or an infrared transmitter. The radio frequency identification tag or the infrared transmitter may be used to communicate with the beacons. In other embodiments including an integrated imaging device (as shown in FIG. 3), the controlling device may include the radio frequency identification tag or the infrared transmitter to communicate with the beacons. The coarse location so determined may be used to automatically select a corresponding location in the virtual layout 370, and upon identification of the illumination devices 50 by the controlling device 80, the illumination devices 50 may be positioned in the selected location in the virtual layout 370 in the computer-generated image 360.

In continuation of the aforementioned example including clusters in the virtual layout, each cluster of the light fixtures 40 may include a cluster beacon. Therefore, once the user 180 or the controlling device 80 reaches a particular cluster, the beacon provides the coarse location of the user 180 or the controlling device 80 to a network server (not shown) based on which the said cluster may be automatically selected in the virtual layout. Furthermore, the illumination devices 50 identified by the controlling device 80 in the cluster may be positioned accordingly in the said cluster. Similarly, each cluster may be selected automatically based on the coarse location of the user 180 or the controlling device 80 and the illumination devices 50 may be positioned in such clusters in the virtual layout 370 provided in the computer-generated image 360.

Referring again to FIGS. 2 and 9, upon identification of the illumination device 50, the controlling device 80 is used to control the illumination device 50. In one embodiment, the unique identification code of the illumination device 50 may be transmitted to the network server to obtain data associated with the illumination device 50. The data associated with the illumination device 50 may be used to control the illumination device 50 using the controlling device 80. In one embodiment, the data associated with the illumination device 50 may be used to commission the illumination device 50 or configure the illumination device 50. In one embodiment, the controlling device 80 generates one or more user-configurable options based on the data associated with the illumination device 50. The one or more configurable options may be used by the user 180 to commission or configure the illumination device 50. In some embodiments, the images of the illumination devices 50 may be stored using cloud based services or at a remote location and an administrator may control the illumination devices remotely using a remotely located controlling device.

As mentioned earlier, the controlling device 80 includes a physical gesture-based graphic user interface 380, which is used for controlling the illumination device in step 550. The term “physical gesture” as used herein refers to any movement and sign made using any part of a human body. In one embodiment, a light emitting diode is controlled using the physical gesture-based graphic user interface 380. The physical gesture-based graphic user interface 380 is configured to recognize physical gestures, where the physical gestures are used to operate the controlling device 80 and control the illumination device 50. In addition, the physical gesture-based graphic user interface 380 is also configured to receive a touch based input from the user 180 for operating the controlling device 80. In one embodiment, the physical gesture-based graphic user interface 380 includes a hand gesture-based graphic user interface.

In one embodiment, the physical gesture-based graphic user interface 380 uses the imaging device 120 to obtain gesture images of the physical gestures made by the user 180 and recognizes the physical gesture from the gesture image to control the illumination device 50 based on a recognized physical gesture. In one embodiment, the physical gesture may include a hand gesture. As used herein, the term “hand gesture” may include any movement and sign made using one or both hands, one or both arms, and one or more fingers of one or both hands.

In one embodiment, the physical gesture-based graphic user interface 380 obtains the gesture image of the hand gesture from the imaging device 120. The physical gesture-based graphic user interface 380 further identifies the hand gesture from the gesture image and determines a control command associated with an identified hand gesture. In one embodiment, the physical gesture-based graphic user interface 380 may include predetermined control command associated with predetermined hand gestures. In another embodiment, new hand gestures and control commands may be defined by the user 180 and may be associated with each other. In yet another embodiment, the user 180 may customize existing hand gesture and control commands based on the user's requirements. Furthermore, in one embodiment, the physical gesture-based graphic user interface 380 executes a determined control command and controls the illumination device 50 based on the control command.

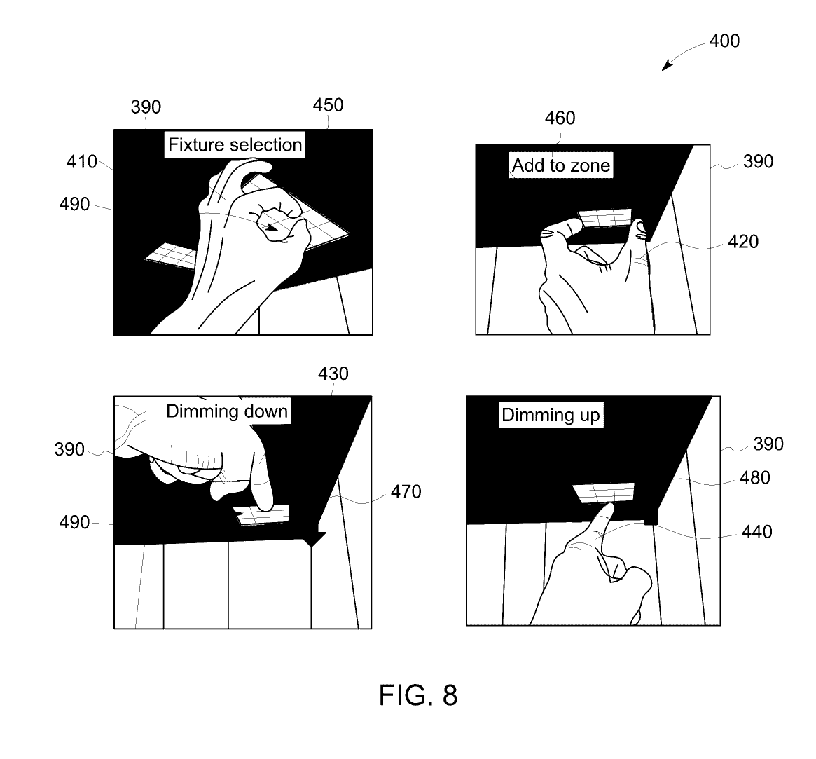

FIG. 8 is an illustrative example 400 depicting different hand gestures 410-440 and control commands 450-480 associated with the corresponding hand gestures 410-440 that are executed by the controlling device 80 for controlling the illumination device 490. In this example, the imaging device 120 is moved to a position such that the illumination device 490 is located within a field of view of the imaging device 120. Furthermore, a hand gesture is made within the field of view of the imaging device 120, which obtains the gesture image 390 of the hand gesture and the illumination device 50. The gesture image 390 captures the illumination pattern 110 generated by the illumination device 50 and the hand gesture 410-440 made by the user 180. The controlling device 80 identifies the illumination device 490 based on the illumination pattern 110 and the physical gesture-based graphic user interface 380 identifies the hand gesture 410-440 from the gesture image 390. Furthermore, the physical gesture-based graphic user interface 380 determines the control command 450-480 associated with the identified hand gesture 410-440 and the controlling device 80 executes the determined control command 450-480 for controlling the identified illumination device 490. For example, a first hand gesture 410 depicts a selection control command 450, which is used to select the illumination device 490. Furthermore, a second hand gesture 420 depicts an addition command 460, which is used to add the selected illumination device 490 to the virtual layout 370 in the computer-generated image 360. Moreover, a third hand gesture 430 depicts a dimming down command 470, which is used to reduce an output level of the illumination device 490. Similarly, a fourth hand gesture 440 depicts a dimming up command 480, which is used to increase the output level of the illumination device 490. It would be understood by a person skilled in the art that any type and number of control commands may be similarly incorporated in the physical gesture-based graphic user interface 380, which may be executed using the hand gestures to control the illumination device.

Some embodiments of the present specification advantageously use hand gestures to control illumination devices. The illumination devices may be commissioned or configured using the hand gestures, which reduces manual effort. Furthermore, a user may commission the illumination devices without the prior knowledge of a lighting layout design and related lighting infrastructure. Moreover, the illumination devices may be controlled by the user physically present near the illumination device or remotely via a communication channel such as the internet.

It is to be understood that a skilled artisan will recognize the interchangeability of various features from different embodiments and that the various features described, as well as other known equivalents for each feature, may be mixed and matched by one of ordinary skill in this art to construct additional systems and techniques in accordance with principles of this disclosure. It is, therefore, to be understood that the appended claims are intended to cover all such modifications and changes as fall within the true spirit of the invention.

1. A method comprising:
obtaining an image of an illumination device, thereby capturing an illumination pattern generated by the illumination device based on a visible light communication technique;
identifying the illumination pattern based on the image;
determining a unique identification code of the illumination device based on the illumination pattern;
representing the illumination device in a computer-generated image based on the unique identification code; and
controlling the illumination device using a physical gesture-based graphic user interface.

2. The method of claim 1, wherein controlling the illumination device comprises at least one of commissioning the illumination device and configuring the illumination device.

3. The method of claim 1, wherein controlling the illumination device comprises using a hand gesture.

4. The method of claim 3, further comprising:
obtaining a gesture image of the hand gesture;
identifying the hand gesture based on the gesture image;
determining a control command associated with the hand gesture; and
controlling the illumination device based on the control command.

5. The method of claim 1, wherein obtaining the image of the illumination device comprises obtaining a video clip of the illumination device.

6. The method of claim 5, wherein obtaining the video clip of the illumination device comprises obtaining a first video clip of a first illumination device and a second video clip of a second illumination device.

7. The method of claim 6, wherein obtaining the first video clip of the first illumination device and the second video clip of the second illumination device comprises obtaining the first video clip of a first set of illumination devices and obtaining the second video clip of a second set of illumination devices.

8. The method of claim 6, further comprising collating the first video clip and the second video clip to form the video clip.

9. The method of claim 5, further comprising identifying the illumination pattern of a plurality of illumination devices from the video clip.

10. The method of claim 1, further comprising performing a cyclic redundancy check upon determining the unique identification code of the illumination device.

11. The method of claim 1, wherein representing the illumination device in the computer-generated image comprises representing the illumination device in an augmented reality space or a virtual reality space.

12. The method of claim 1, further comprising transmitting the unique identification code of the illumination device to a network server for obtaining data associated with the illumination device.

13. The method of claim 1, wherein controlling the illumination device comprises generating one or more user-configurable options in the physical gesture-based graphic user interface based on a data associated with the illumination device.

14. The method of claim 1, wherein controlling the illumination device comprises controlling a light emitting diode.

15. A system comprising:
an imaging device configured to obtain an image of an illumination device, thereby capturing an illumination pattern of the illumination device generated based on a visible light communication technique; and
a controlling device configured to determine a unique identification code of the illumination device based on the illumination pattern and enable a user to control the illumination device using a physical gesture-based graphic user interface.

16. The system of claim 15, wherein the physical gesture-based graphic user interface comprises a hand gesture-based graphic user interface.

17. The system of claim 15, wherein the controlling device is configured to identify a plurality of hand gestures and generate a control command associated with the plurality of hand gestures.

18. The system of claim 15, wherein the controlling device comprises a portable controlling device.

19. The system of claim 18, wherein the portable controlling device comprises a tablet or a smartphone.

20. The system of claim 15, wherein the illumination device comprises a light emitting diode (LED).

21. The system of claim 15, further comprising a visible light communication (VLC) controller.

22. A lighting system comprising:
a light fixture configured to be operatively coupled to an illumination device;
a visible light communication controller configured to be operatively coupled to at least one of the illumination device or the light fixture;
an imaging device configured to obtain an image of the illumination device, thereby capturing an illumination pattern of the illumination device generated based on a visible light communication technique; and
a controlling device configured to determine a unique identification code of the illumination device based on the illumination pattern and enable a user to control the illumination device using a physical gesture-based graphic user interface.

23. The lighting system of claim 22, wherein the visible light communication controller is disposed within the light fixture or the illumination device.
